(19) United States
(12) Patent Application Publication
(10) Pub. No.: US 2013/0128912 A1
(43) Pub. Date: May 23, 2013

(54) CRUCIBLE HAVING A POLYGONAL OPENING

(71) Applicant: Laurent Molins, Souppes Sur Loing (FR)

(72) Inventor: Laurent Molins, Souppes Sur Loing (FR)

(73) Assignee: SAINT-GOBAIN QUARTZ S.A.S., Courbevoie (FR)

(21) Appl. No.: 13/812,064

(22) PCT Filed: Jul. 12, 2011
(86) PCT No.: PCT/FR11/51667

§ 371 Date: Jan. 24, 2013

(30) Foreign Application Priority Data
Jul. 27, 2010 (FR) 1056161

(51) Int. Cl. C03B 5/02

(52) U.S. Cl. CPC C03B 5/025
USPC 373/27

(57) ABSTRACT

The invention relates to an arc melted silica crucible having a polygonal opening, in particular square or rectangular, and its method of fabrication, which comprises preforming the silica powder in a hollow mold having a polygonal opening, said mold being provided with a multiplicity of channels passing through its bottom and its walls, said channels being distributed over its whole internal surface, to constitute a preform, then melting the silica by an electric arc inside the preform, sucking the gases through the mold and the preform, generating a gas speed of at least 0.15 m/second at every point of the inner surface of the preform at the onset of the melting.

The invention relates to a crucible having a polygonal shape and its method of preparation.

Today, a number of industrial applications, in particular in the field of semiconductors, solar energy (photovoltaic) or for the calcination of alumina powders, phosphorescent powders or precious metals, use silica crucibles. Two methods for fabricating these crucibles are distinguished in particular: one employing the melting of the silica, and the other employing the preparation of a slip followed by sintering (slip cast method).

Slip cast crucibles have the drawback of having a slightly porous surface. This surface can be glazed by flame or electric arc, but residual micro-bubbles remain just below the glazed surface. Glazing is also a relatively costly manual operation. This technique serves to obtain crucibles having square, round or rectangular shapes fairly simply. The dense glazed surface is very fine and is no more than 0.5 mm thick.

As to molten silica crucibles having a circular opening, the following two methods are distinguished:
preparation of a hollow silica ingot, followed by blowing of said ingot in a mold; this technique has the drawback of yielding products having surface imperfections such as burst bubbles, deformations, high porosity;
preparation by electric arc melting in air in a rotary mold (autocrucible, graphite mold, metal mold, cooled metal mold). Pieces with a very fine surface texture can thus be obtained. These surfaces are said to be glazed and are free of bubbles. The melting of quartz powder by an electric arc is a very widespread method for fabricating quartz crucibles having excellent surface quality. A person skilled in the art immediately recognizes an arc melted silica crucible because it has a very uniform or “glazed” surface texture. For arc melting according to the prior art for producing crucibles having a circular opening, the batch is introduced into a hollow mold rotating about the axis of revolution of the crucible to be produced, and the centrifugal force distributes and maintains the quartz powder on the walls of this mold. This rotation, usually higher than 150 RPM, is maintained throughout the melting process. The powder is placed in a porous mold across which suction is applied. Heating by an electric arc then serves to melt the silica and thereby fabricate the crucible.

Many industries use crucibles fabricated by electric arc because of their surface quality, their surface reactivity in use also being much lower than that of slip cast crucibles or foundry-produced crucibles (melting an ingot followed by blowing). Their service life is also longer and the quality of the products fabricated is higher, particularly in terms of pollution by the silica from the crucible. This technique is only employed today to produce pieces having a circular opening.

When the crucible is used for powder calcination, a larger number of square crucibles than round crucibles can be aligned on the same area (21% more). Hence the use of round crucibles implies a loss of capacity, energy and productivity.

JP58088129 teaches a method for fabricating a square crucible by arc melting. According to this method, no suction is applied. In the absence of suction, a high porosity is necessarily created in the crucible walls, making it impossible to obtain a specific gravity of at least 2.15 over a depth of at least 1.5 mm from the interior of the crucible.

The invention relates to an arc melted silica crucible having a polygonal opening. The crucible has a polygonal opening, that is to say, has at least three sides (or four or five or six sides), generally four sides, in particular square, rectangular, or diamond shaped, and it is fabricated by electric arc melting. The polygonal shape, in particular regular, serves to juxtapose a multiplicity of crucibles easily, so as to occupy a maximum area. Square and rectangular shapes are preferred. It would remain within the scope of the present application if the sides of the polygon are slightly rounded. Similarly, it would remain within the scope of the present application if the angles of the polygon are slightly rounded. In general, the angles of the polygon (angles between two adjacent side walls at the rim of the crucible) have a radius of curvature lower than 25 mm at the rim of the final crucible for the case in which the polygon has four sides and is square or rectangular.

The crucible according to the invention has a characteristic appearance of fabrication by electric arc. Moreover, the use of the electric arc causes a high silica density over a high depth starting from the interior of the crucible. The theoretical density of molten silica is 2.2 g/cm³ and it is very difficult in practice to approach this value by a method other than melting. The use of the electric arc to melt the entire crucible serves to obtain a density of at least 2.15 g/m³ over a depth of at least 1.5 mm, or even at least 2 mm from the interior of the crucible (side walls and bottom of the crucible).

According to the invention, the same electric arc method is used as to produce a crucible having a circular opening, except that a sufficient suction force is applied to maintain the shape imparted to the powder without any need for or even utility of rotation. This suction is also the source of the very high density over a depth of at least 1.5 mm, or even at least 2 mm from the interior of the crucible. In fact, the suction removes any gas, which can no longer remain in the form of bubbles in the crucible. Moreover, the suction also serves to counteract the blowing of the plasma, which tends to shift the powder preformed in the mold, particularly on the bottom. A mold having very high permeability is preferably used, so that the powder is pressed against the walls by suction through the mold in order to prevent the blowing of the electric arc from distorting the silica powder preform. To be able to apply this suction, the mold may be provided with a multiplicity of orifices distributed in all the walls (side walls and bottom).

The rotation of the mold during the melting is not ruled out, but it is not indispensable and may in any case be at low speed.

According to the invention, the suction force must be sufficient for the gases flowing through the preformed powder to have a speed of at least 0.15 m/second and preferably at least 0.2 m/s and even at least 0.3 m/s, at least at the time when the silica begins to melt. The suction is therefore applied at this speed no later than the time when the electric arc begins to operate in the internal volume of the future crucible (powder preformed at this stage or “preform”). This suction speed has been found to ensure maintenance of the powder in its crucible shape without the need for rotation about a vertical or substantially vertical axis, as is commonly done in the case of crucibles having a circular opening. The speed of the gases flowing through the powder can be measured at the preform surface by a hot wire anemometer, like for example the TESTO 425 sold by TESTO. This suction through the preform is applied at the onset of the melting of the silica because a sealed silica skin is rapidly formed on the inner surface of the preform, thereby plugging the preform and precluding the possibility of suction. The suction is continued at least until the formation of the sealed silica skin on the inside of the preform. Thus the invention also relates to a method for fabricating a crucible comprising
preforming the silica powder in a hollow mold having a polygonal opening, said mold being provided with a multiplicity of channels passing through its bottom and its walls, said channels being distributed over its whole internal surface, to constitute a preform, then
melting the silica by an electric arc inside the preform, sucking the gases through the channels of the mold and of the preform, generating a gas speed of at least 0.15 m/second and preferably at least 0.2 mls, even at least 0.3 m/second, at every point of the inner surface of the preform at the onset of the melting.

It is not ruled out to apply a rotation, preferably moderate, which is preferably lower than 200 revolutions per minute (RPM) and more preferably lower than 150 RPM and even more preferably lower than 100 RPM and even lower than 50 RPM, or even nil. Rotation tends to impart a parabolic shape to the contents of the mold, which is unfavorable to the proper maintenance of a polygonal shape, especially in the angles. It has in fact been observed that the faster the rotation, the more the angle formed by the adjacent side walls deviates from a right angle (case of a square or rectangular polygon). Any rotation is applied about an axis passing through the barycenter of the preform or of the final crucible. This axis may be vertical or inclined and, in this case, generally at an angle of less than 15° to the vertical. This axis is generally perpendicular to the bottom of the preform and of the final crucible and therefore perpendicular to the opening of the preform and of the final crucible. If no rotation is applied during the implementation of the inventive method, the preform and the final crucible are placed so that its opening (and its bottom) is horizontal or makes an angle of less than 15° to the horizontal. Any rotation is applied in particular during the melting. It may also be applied before the melting and also during the cooling.

For the implementation of the inventive method, a device can be used comprising
a hollow mold having a polygonal opening, provided with a multiplicity of channels passing through its bottom and its walls and distributed over its entire internal surface (interior of the mold) and its side walls and bottom;
a system for sucking out the gas present in the mold, connected to said channels via the exterior of said mold,
a system for introducing silica powder into the mold,
a system for preforming the silica powder in the mold,
electrodes generating a gas plasma in the mold.

If necessary, the device may comprise a system for rotating the hollow mold about an axis passing through the barycenter of the preform or of the crucible. This axis may be vertical or inclined and, in this case, generally at an angle of less than 15° to the vertical. This axis is generally perpendicular to the bottom of the preform or of the final crucible.

The device may comprise a system for controlling the gas (type and flow rate) constituting the atmosphere in the mold if said gas is not air. However, in general, the atmosphere is air and no gas control system is therefore necessary.

The hollow mold may be made from metal (in particular stainless steel or nickel alloy such as an INCONEL) and provided with porous inserts, or porous metal inserts, or inserts of a porous material such as porous graphite. For the case in which the mold comprises a metal, it may or may not be cooled, for example by an internal water circulation. The porous elements of the mold are intended to allow the suction through the mold to act on the preformed silica powder.

The mold is preferably flared upward (that is to say its rim), which means that the cross sectional area of its opening (at the rim) is larger than the area of its bottom. This feature offers two advantages:
a) the crucible obtained is stripped from the mold more easily;
b) the crucible obtained has an inner shape that is also flared upward (that is to say, the area of its opening is greater than the area of its bottom), which makes it easier to strip a solidified material contained in the crucible from the mold.

In general, the mold has a flat bottom, and the resulting crucible also generally has a flat bottom. The crucible prepared according to the invention has side walls with a particularly constant thickness. The variation of thickness of the side walls is less than 20%. This thickness variation is calculated by (Eₘₐₓ−Eₘᵢₙ)×100/Eₘᵢₙ where Eₘₐₓ is the maximum thickness and Eₘᵢₙ is the minimum thickness.

After having deposited the silica powder in the mold, it is given the appropriate shape for example using a strickling blade or any other shaping tool. Quartz powder can also be placed between the mold and a backing mold. After having removed the backing mold, quartz powder, preformed and ready to melt, remains in the mold. The silica powder to be preformed may contain some water, in particular 0.05 to 40% by weight of water, generally 10 to 25% by weight of water. This water helps to maintain the shape of the preform.

The system for sucking the gas from the mold comprises a vacuum pump. A vacuum system for obtaining a partial pressure of 10 mbar in a perfectly gastight system is generally sufficient. After depositing the quartz powder in the porous mold, a sufficient flow is provided across the quartz powder and the mold for the gas to be sucked out at the requisite speed. This gas flow is obtained after filling the mold but before starting the electric arc. The suction system is generally connected to a melting pot, which is a metal container inside which the mold has been placed. The mold is generally tightly attached to the melting pot, so that the suction created in the melting pot is entirely communicated to the channels passing through the mold.

The mold may be of the autocrucible type, that is to say, made from silica. In this case, a bed of coarse silica grains is formed in the melting pot, the desired shape for the preform is imparted to it, and the silica preform to be melted is then placed inside said bed. Here, the silica grains of the bed must be coarse enough to allow the suction to reach the desired gas speeds at the onset of melting. The space between the coarse silica grains forms channels passing through the walls and bottom of the autocrucible mold.

The electrodes generating gaseous plasma in the mold are generally made from graphite and are generally three or more (generally up to nine) in number and supplied with multiphase electric power (three-phase if three electrodes or six electrodes are used). A single-phase system is also feasible. The power delivered depends on the size of the crucible to be fabricated, which generally has an opening area of

5.10⁻⁴ to 6.5 m². For these crucible sizes, the wattages are generally between 200 and 3000 kW, the lowest power being used for the smallest crucibles and vice versa. In the case of large crucibles, the electric arc may be generated using hexa-phase or nona-phase electrodes or by a three-phase system of three or six electrodes. Thus, the crucible according to the invention may even have an opening area greater than 0.25 m² and even greater than 0.5 m² and even greater than 0.9 m².

The system, if any, for controlling the type of gas constituting the atmosphere in the mold is a source of the gas which has been selected as the atmosphere in the mold. This gas is a plasmagene gas. This gas may, for example, be helium, oxygen-enriched helium (generally 5 to 15% of oxygen in the helium), hydrogen (difficult to use due to its dangerousness), air, argon or even nitrogen, or even any mixture of these various gases. Pure helium or helium containing a little oxygen is particularly suitable, especially in the phase of formation of the dense silica layer due to its high diffusion rate, reducing the risk of trapping gas bubbles.

After having started the suction through the mold and the silica preform, the electric arc is introduced into the volume of the preform. The silica is heated as rapidly as possible with a high plasma power until a sealed skin of molten silica is formed on the inner surface of the crucible being formed, which corresponds to the closure of the surface pores on this side (facing the plasma). The closure of these pores is easily observed by measuring and recording the pressure in the suction system. The closure of these pores causes a sharp and rapid drop in pressure in the pumping circuit. This initial step begins at a pressure generally between 50 and 600 mbar (this is the equilibrium pressure procured by the pump running at full speed through the mold and the still unmelted silica in the mold) and continues until obtaining a reduced pressure, the value of which depends on the capacity of the pump but which is generally lower than 100 mbar and generally between 80 and 5 mbar. This initial step lasts about 20 to 150 seconds. After this sealed skin formation step, the plasma power can be decreased by changing the voltage across the electrode terminals. This gives rise to a second and lower plasma strength. The quartz grains located behind the sealed skin are then melted under low pressure, causing the thickening of the dense silica layer, which is transparent and virtually free of bubbles. When the melted transparent layer under low pressure is sufficiently thick (between 30 and 70% of the total thickness of the crucible) the suction can be stopped to continue the melting cycle at atmospheric pressure or at least at a pressure above 700 mbar in the suction system. This step of more moderate heating at higher pressure favors the creation of a porous layer (opaque or slightly translucent) that is fairly far from the inner surface of the crucible. A silica layer is thereby obtained, comprising many bubbles located toward the outer surface of the crucible. This high porosity on the outer surface gives the crucible a thermal insulation property.

The inventive method gives rise to a virtual absence of bubbles over a depth of generally between 1 and 6 mm measured from the inner surface of the crucible. The layer of bubbly silica (opaque or slightly translucent) has a thickness of 1 to 20 mm in general.

On the whole, after the sealed surface skin is formed, the electric power used may be 10 to 40% lower than the power used for the formation of the sealed skin at the onset of heating. Thus operation at high power occurs over a very short time, thereby limiting the evaporation of silica. In fact, silica evaporation necessarily gives rise to condensation in a colder zone, which generates silica particles falling back into the crucible. These particles must be avoided, because they generate prohibitive defects for certain applications. Before starting the melting, the layer of quartz grains in the mold (thickness of the preform) generally has a thickness between 13 and 40 mm. The final crucible generally has a thickness of 6 to 26 mm.

After fabricating the crucible according to the invention by the electric arc melting method, it can be coated with a layer of a metal or metal oxide or hydroxide or nitride or carbide or oxynitride or oxycarbide or carbonitride or oxycarbonitride on its inner and/or outer surface (it is considered here that Si, Ba and Y are metals). It is possible in particular to deposit a layer of barium or barium oxide or barium hydroxide or yttrium oxide or silicon nitride on the inner and/or outer surface of the crucible. For the deposition and the advantage procured by such layers, reference can be made in particular to WO9424505, U.S. Pat. No. 5,976,247, U.S. Pat. No. 5,980,629.

The crucible according to the invention has many applications and particularly for:
calcining powders (phosphorescent, fluorescent, alumina, etc.);
refining precious metals (gold, silver, platinum, etc.);
fabricating synthetic gems;
melting and refining special alloys (in the form of powders, beads, granules, etc.);
metalizing parts by evaporation;
the melting and/or crystallization of metal ingots by direct solidification or zone melting or other processes (silicon or other metals, semiconductors or not).
   The crucible according to the invention has laboratory uses, in particular:
for melting glass;
for the calcination or heating of acids or chemicals mixed with acids (HF, HCl, etc.);
as an etching or washing vessel (cleaning, etching) for wafers in the semiconductor industry;
for the heat treatment of parts (especially binder stripping);
for melting superalloys (for turbine blades, for example) in connection with their hot molding (melting/solidification);
for melting silicon for solar applications, the silicon being solidified in the crucible; depending on the crystallization process, single-crystal or multicrystalline silicon ingots can be obtained;
for producing preforms, boxes transparent to electromagnetic waves for industrial radiofrequency applications (like induction) or radiotransmissions (like radome);
as reactors for the treatment of wafers (epitaxy, miscellaneous deposits).

Thus, the invention also relates to the use of the crucible for calcining powder, in particular alumina powder or phosphorescent powder or luminescent powder, or rare earth powder or for melting metal, in particular precious metal, or for melting silicon, in particular single-crystal or multicrystalline silicon.

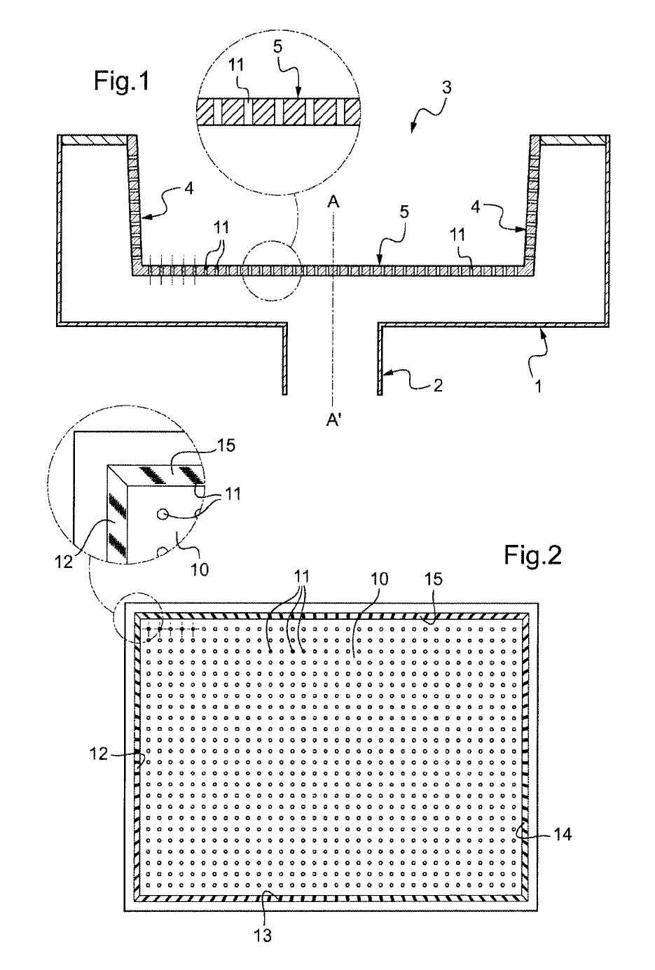

FIG. 1 shows the system for receiving the silica powder. A melting pot 1 is connected by a line 2 to a vacuum pump (not shown). The mold 3 is tightly attached to the melting pot via its rim. This mold consists of substantially vertical walls 4 (slightly oblique to the vertical as in most crucibles) and a bottom 5. These walls 4 and the bottom 5 have been perforated and the orifices 11 made are filled with porous metal inserts (not shown) allowing the suction applied between the melting pot 1 and the mold 3 to pass through. Moderate rotation may optionally be applied about axis AA′, which passes through the barycenter of the preform or of the final crucible and is perpendicular to the opening and the bottom of the preform or of the final crucible. The walls 4 can be seen to move apart upwardly to give a flared shape to the mold and, in consequence, to the silica crucible finally produced. In this way, the area of the opening (area of the opening at the top of the walls 4) is greater than the area of the bottom 5. The same applies to the silica crucible formed.

FIG. 2 shows a mold having a rectangular opening seen from above the opening side. On the bottom wall 10, orifices 11 can be seen, aligned and provided with porous inserts. The mold is provided with four side walls (12, 13, 14, 15) which are also perforated and provided with porous inserts like the bottom 10. Thus, the suction applied in the melting pot is applied to all the walls and to the bottom of the silica preform.

### EXAMPLE 1

This example describes the fabrication of a silica crucible having a square opening measuring 250×250 mm, and having a height of 160 mm. The silica was melted by an electric arc generated by a group of three electrodes supplied with three-phase electricity, and having respective diameters of 36 mm/38 mm/36 mm. The electric power delivered by the electrodes was 230 KWh. Silica tubes circulating cooling water were placed 50 mm above the mold to act as a heat shield. These tubes were not joined, so that the electrodes could pass between them. A mold was placed in the melting pot, the mold walls being separated by a few centimeters from the walls of the melting pot. Gas could thereby circulate between the melting pot and the mold. The mold was made from NS30 refractory stainless steel. Internally, this mold had the desired shape for the exterior of the crucible. The stainless steel forming its structure was perforated with a multiplicity of 5 mm diameter orifices, the hole density was about 1 hole per cm², and each hole was filled with a SIKA R AX100 porous metal pellet sold by GKN Filter. A layer of 27 mm of dry Cristal IOTA standard silica powder sold by Unimin was placed in this mold. The silica was preformed by a backing mold pressing the silica powder inside the mold, and said backing mold was then removed.

At the start of the process, the electrodes were placed 250 mm above the mold (hence about 200 mm above the heat shield) and in the central position (in an axis passing through the point of intersection of the diagonals of the square of the opening and therefore also through the barycenter of the final crucible or of the preform; this axis was perpendicular to the bottom of the crucible or of the preform). The plasma was ignited in this position, the electrodes then followed a route inside the crucible being formed to be immersed up to 30 mm (vertically) in the mold (30 mm below the rim of the crucible) and to approach to within 10 mm of the vertical walls of the crucible being formed. Before igniting the plasma, gas suction was applied across the mold and therefore across the preformed silica at a rate of 200 Nm³/h (normal m³ per hour). The gas speed across the silica was 1.5 m/s. No rotation was applied to the mold (and hence to the crucible being formed) during fabrication. A molten silica crucible was finally obtained, having a fine appearance, uniform thickness and devoid of any apparent defects (no blisters or visible irregularities). It had a wall thickness of 6 mm. The interior of the angles between the side walls had a radius of curvature of less than 25 mm at the rim of the crucible.

### EXAMPLE 2

### Comparative

The same procedure was followed as in Example 1 except that the initial silica powder was wetted (12% by weight of water), and the suction force at the onset of melting was only 20 Nm³/h, procuring a gas speed of 0.1 m/s at the silica. The final crucible had some deformations (sometimes called blisters).

### EXAMPLE 3

### Comparative

The same procedure was followed as in Example 1 except that no metal mold was placed in the melting pot, but an autocrucible was formed with 5 mm silica beads in direct contact with the melting pot and a thickness of 30 mm, followed by a layer of coarse-grained sand (particle size about 100-300 μm). The silica powder to be converted to a crucible was then positioned. The suction speed was about 1 m/s at the bottom but less than 0.03 m/s at the walls. The final crucible had deformations (sometimes called blisters).

### EXAMPLE 4

### Comparative

The same procedure was followed as in Example 3, except that the melting pot (and obviously its contents) was rotated at 150 RPM. The rotation of the mold tended to generate a radius of curvature higher than 30 mm at the angles of the final crucible. The final crucible also had deformations (sometimes called blisters).

### EXAMPLE 5

### Comparative

The same procedure was followed as in Example 1, except that the melting pot (and obviously its contents) was rotated at 150 RPM about a vertical axis passing through its barycenter. The rotation of the mold tended to generate a radius of curvature higher than 30 mm at the angles between the adjacent side walls of the final crucible.

1. An arc melted silica crucible, comprising a polygonal opening, wherein the crucible has a specific gravity of at least 2.15 over a depth of at least 1.5 mm from an interior of the crucible.

2. The crucible, of claim 1, wherein the polygon has four sides.

3. The crucible of claim 1, wherein the polygonal opening has an area greater than 0.25 m².

4. The crucible of claim 3, wherein the polygonal opening has an area greater than 0.5 m².

5. The crucible of claim 1, wherein the area of the polygonal opening is larger than the area of its bottom.

6. The crucible of claim 1, further comprising, on an inner surface, an outer surface, or a combination thereof:
a coating comprising a layer comprising a metal or a metal oxide or hydroxide or nitride or carbide or oxynitride or oxycarbide or carbonitride or oxycarbonitride.

7. The crucible of claim 6, wherein the layer comprises barium, barium oxide, barium hydroxide yttrium oxide, or silicon nitride.

8. A method for fabricating an arc melted silica crucible comprising a polygonal opening, the method comprising:
preforming a silica powder in a hollow mold comprising a polygonal opening, wherein the mold comprises a multiplicity of channels passing through its bottom and its walls, wherein the channels are distributed over its whole internal surface, to constitute a preform; then
melting the silica powder with an electric arc inside the preform, sucking a gas through the channels of the mold and of the preform, generating a gas speed of at least 0.15 m/second at every point of the inner surface of the preform at the onset of the melting.

9. The method of claim 8, wherein the preform does not rotate during the melting or rotates during the melting about an axis perpendicular to the polygonal opening and passing through its barycenter at a speed lower than 150 RPM.

10. The method of claim 9, wherein the preform does not rotate during the melting or rotates during the melting about an axis perpendicular to the polygonal opening and passing through its barycenter at a speed lower than 100 RPM.

11. The method of claim 10, wherein the preform does not rotate during the melting or rotates during the melting about an axis perpendicular to the polygonal opening and passing through its barycenter at a speed lower than 50 RPM.

12. The method of claim 8, wherein the speed of the gas created at every point of the inner surface of the preform at the onset of the melting is at least 0.2 m/second.

13. The method of claim 12, wherein the area of the mold opening is greater than the area of the mold bottom.

14. The method of claim 8, wherein the silica powder is preformed with 0.05 to 40% by weight of water.

15. The method of claim 8, wherein a plasma is produced by supplying three-phase electric power to six electrodes.

16. A method, comprising:
calcining a powder or melting a metal or silicon in the crucible of claim 1.

17. The crucible of claim 1, further comprising, on an outer surface thereof:
a layer comprising porous silica, wherein the layer has a thickness of 1 to 20 mm.

18. The crucible of claim 3, wherein the polygonal opening has an area greater than 0.9 m².
